(19) United States
(12) Patent Application Publication
(10) Pub. No.: US 2017/0368688 A1
(43) Pub. Date: Dec. 28, 2017

(54) METHOD AND APPARATUS FOR ADJUSTING INTERACTIVE DIRECTIONS OF ROBOTS

(71) Applicant: Qihan Technology Co., Ltd., Shenzhen (CN)

(72) Inventors: Lvde Lin, Shenzhen (CN); Yongjun Zhuang, Shenzhen (CN)

(21) Appl. No.: 15/239,884

(22) Filed: Aug. 18, 2016

(30) Foreign Application Priority Data
Jun. 27, 2016 (CN) 201610481974.5

(51) Int. Cl. B25J 11/00; G06T 7/60; G10L 25/48; G06F 3/16; G06K 9/00; G10L 17/22

(52) U.S. Cl. CPC B25J 11/0005; G06K 9/00221; G10L 17/22; G10L 25/48; G06F 3/167; G06T 7/60; G06T 2207/30242; G06T 2207/30201

(57) ABSTRACT

The present invention is applied to the human-robot interaction field, and provides a method and apparatus for adjusting interactive directions of robots; the method includes: determining an original direction where a voice signal is generated upon receiving a voice signal; switching a robot from a current direction to the original direction, and capturing a picture corresponded to the original direction; detecting whether a human face exists in the picture; when a human face exists in the picture, determining a required adjustment angle according to a location of the human face in the picture; and adjusting the robot according to the required adjustment angle. Through the above method, the determined location and direction obtained after the adjustment is more precise.

### FIELD OF THE INVENTION

The present invention belongs to the field of human-robot interaction, especially relates to a method and an apparatus for adjusting interactive directions of robots.

### BACKGROUND

A robot is a mechanical apparatus capable of performing work automatically, it can not only accept human instructions but also run pre-programmed procedures, and can also act in accordance with principles and programs established by an artificial intelligence technology.

When an existing robot detects a voice signal of a user, the robot estimates the user's location and direction according to a sound source positioning technology; and when receiving an instruction of going forward sent by the user, the robot controls itself to rotate towards the estimated location and direction. However, since the voice signal transmits in all directions in the form of waves; it is not precise enough to determine the location and direction of the user of the robot according to the sound source positioning technology merely.

### BRIEF DESCRIPTION

Embodiments of the present invention provide a method and apparatus for adjusting interactive directions of robots, which aim to solve the problem that an existing robot determines a location and a direction of a user merely based on a sound source and thus results in that the determined location and direction are inaccurate.

The invention is realized as follows. A method for adjusting an interactive direction of a robot, comprising:

upon receiving a voice signal, determining a corresponding original direction where the voice signal is generated;

adjusting the robot from a current direction to the original direction, and capturing a picture corresponding to the original direction;

detecting whether a human face exists in the picture;

when a human face exists in the picture, determining a required adjustment angle according to the location of the human face in the picture; and

adjusting the robot according to the required adjustment angle.

Another purpose of the embodiments of the present invention is to provide an apparatus for adjusting an interactive direction of a robot, comprising:

a voice signal receiving unit configured to determine a corresponding original direction where the voice signal is generated upon receiving a voice signal;

a picture capturing unit configured to adjust the robot from a current direction to the original direction, and capture a picture corresponded to the original direction;

a human face detecting unit configured to detect whether a human face exists in the picture;

a required adjustment angle determining unit configured to determine a required adjustment angle according to the location of the human face in the picture when a human face exists in the picture; and

an angle adjustment unit configured to adjust the robot according to the required adjustment angle.

In the embodiments of the present invention, after the robot is adjusted from a current direction to a determined original direction, a required adjustment angle is further determined according to the location of the human face in the picture; therefore, the determined location and direction obtained after adjustment are more precise, and the robot correspondingly adjusted according to the required adjustment angle can communicate with the user face to face, such that the intellectuality of human-robot interaction is improved; furthermore, the face to face interaction between the robot and the user is more realistic and natural.

### BRIEF DESCRIPTION OF THE DRAWINGS

FIG. 1 is a flow chart of a method for adjusting an interactive direction of a robot provided by a first embodiment of the present invention;

FIG. 2 is a schematic view of determining a corresponding specific location where a voice signal is generated provided by the first embodiment of the present invention;

FIG. 3 is schematic view of determining a required adjustment angle according to a location of a captured human face in a captured picture provided by the first embodiment of the present invention; and

FIG. 4 shows an apparatus for adjusting an interactive direction of a robot provided by a second embodiment of the present invention.

### DETAILED DESCRIPTION

In order to make the purposes, technical solutions and advantages of the present invention more clear, the invention will be further described in detail with reference to the drawings and the embodiments. It is to be understood that the specific embodiments described herein are merely intended to explain the present invention but not to limit the present invention.

In an embodiment of the present invention, determining a corresponding original direction where the voice signal is generated upon receiving a voice signal; adjusting the robot from the current direction to the original direction, and capturing a picture corresponded to the original direction, detecting whether a human face exists in the picture or not; when a human face exists in the picture, determining a required adjustment angle according to the location of the human face in the picture, and adjusting the direction of the robot according to the required adjustment angle.

In order to illustrate the schemes of the present invention, specific embodiments are described as follows:

### The First Embodiment

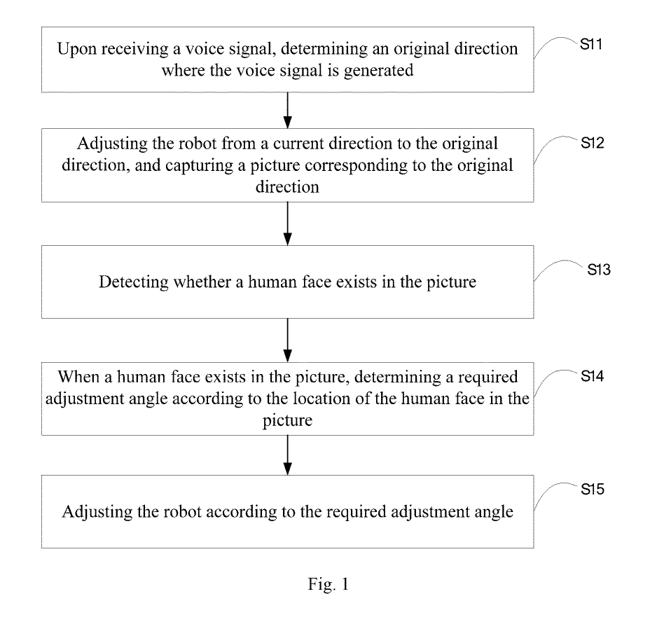

FIG. 1 illustrates a flow chart of a human-robot interactive method provided by the first embodiment of the present invention; details of the first embodiment are as follows:

Step 11. Upon receiving a voice signal, determining an original direction where the voice signal is generated.

In this step, after receiving the voice signal, the robot estimates the original direction corresponding to the voice signal according to a sound source positioning technology. For example, when receiving a plurality of voice signals, the robot estimates the original direction corresponding to the strongest voice signal according to the positioning technology.

Optionally, in order to avoid interference and save electricity, the step 11 specifically includes:

A1. Judging whether the voice signal is a wakeup instruction or not upon receiving the voice signal. Specifically, identifying the meaning of words and sentences contained in the voice signal; if the meaning of the words and sentences contained in the voice signal is identical with predefined meaning, the voice signal is determined to be a wakeup instruction; otherwise, the voice signal is determined not to be a wakeup instruction. Furthermore, when the meaning of the words and sentences contained in the voice signal is identical with the predefined meaning, further judging whether a frequency and/or tone of the voice signal is identical with a predefined frequency and/or tone; if identical, the voice signal is determined to be a wakeup instruction; otherwise, the voice signal is determined not to be a wakeup instruction.

A2. When the voice signal is a wakeup instruction, determining the original direction where the voice signal is generated.

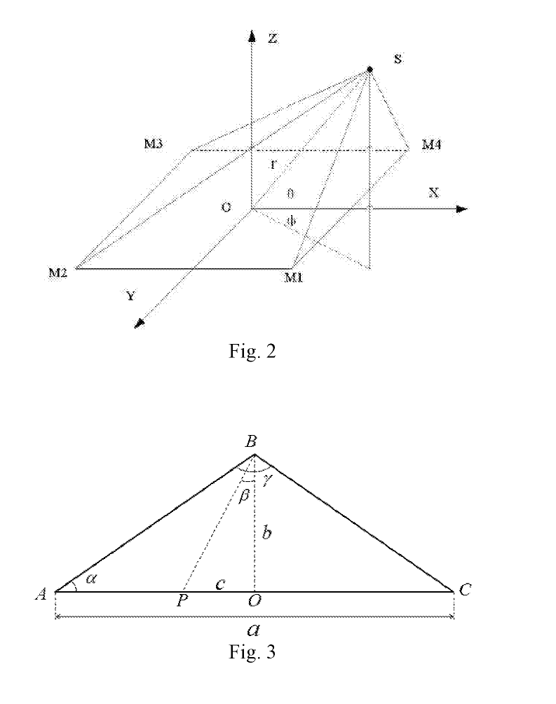

Specifically, the original direction corresponding to the voice signal can be estimated through the sound source positioning technology. Surly, if the specific location where the voice signal is generated requires being determined, it can be determined by a time difference between received voice signals. For example, the robot is provided thereon with four microphones; an array of the four microphones is a four-element cross array, and the four microphones are arranged in the same plane in a cross shape, wherein S denotes the location of voice source; M1, M2, M3, M4 respectively denote locations of four elements (i.e., the microphones) in the four-element cross array, as shown in FIG. 2. Wherein, a target azimuth angle is φ, a sound source elevation angle is θ (i.e., an angle constituted by \vec{OS} and \vec{OX}); r is a distance between the target voice source (i.e., S) and the ordinate origin O; a time difference between voices received by two microphones Mᵢ and Mⱼ is denoted by tᵢⱼ. Thus, the original direction and location where the voice signal is generated can be determined by the following equation:

$$\{ \begin{matrix}tan φ = \frac{{t}_{41} + {T}_{31} - {t}_{21}}{{t}_{21} + {t}_{31} - {t}_{41}} \\ cos θ = \frac{C}{L} \sqrt{\frac{{t}_{31}^{2} + {( {t}_{41} - {t}_{21} )}^{2}}{2}} \\ r = \frac{C [ {t}_{31}^{2} + {( {t}_{41} - {t}_{21} )}^{2} ]}{4 ( {t}_{41} - {t}_{31} + {t}_{21} )}\end{matrix}$$

Step 12. Adjusting the robot from a current direction to the original direction, and capturing a picture corresponding to the original direction.

After determining the original direction, if the current direction of the robot is not identical with the original direction, the robot is adjusted from the current direction to the original direction, and the picture corresponding to the direction is captured by a picture capturing apparatus such as a camera, a high-definition colored vidicon and so on; the picture can be a 2D picture or a 3D picture.

Step 13. Detecting whether a human face exists in the picture.

Specifically, the robot detects whether a human face exists in the picture by a face detection algorithm.

Step 14. When a human face exists in the picture, determining a required adjustment angle according to the location of the human face in the picture.

Optionally, in order to make the communication between the robot and the user be more natural and more realistic, it is possible to adjust a certain angle such that the robot communicates with the user face to face and the intellectuality of human-robot interaction is improved. The step 14 specifically includes:

B1. When a human face exists in the picture, judging whether the number of the human face is more than one.

B2. When the number of the human face is more than 1, choosing a human face with the least depth, and determining the required adjustment angle according to the location of the human face with the least depth in the picture.

B3. When the number of the human face is 1, determining the required adjustment angle according to the location of the human face in the picture.

In the above steps B1-B3, the location of which human face in the picture should be the basis for determining the required adjustment angle is determined: when a plurality of human faces exist in the picture, the face with the least depth is chosen, and the required adjustment angle is determined according to the location of the face with the least depth in the picture. The less the depth is, the shorter the distance between the human and the robot is; and the shorter the distance between a user and a robot is, the greater the possibility that the user is the owner of the robot. Therefore, the required adjustment angle determined according to the depth of the human face is more precise. Since when only one human face exists in the picture, the human face normally belongs to the owner of the robot, the required adjustment angle can be determined only according to the location of the human face in the picture.

Furthermore, the step of determining the required adjustment angle according the location of the human face in the picture includes specifically:

determining a distance c between the human face and a central point of the picture; and determining a width a of the picture;

according to the equation:

$$\{ \begin{matrix}tan α = \frac{2 b}{a} \\ tan β = \frac{c}{b} \\ α = \frac{1}{2} ( π - γ )\end{matrix} ,$$

determining the required adjustment angle:

$$β = arctan \frac{2 c / a}{tan \frac{π - γ}{2}} ;$$

Wherein, α is the angle between the plane where the picture lies and the line connecting the robot with a left or right side of the picture; b is the distance between the robot and the central point of the picture; β is the required adjustment angle; γ is a visual angle of the robot.

As shown in FIG. 3, B is the location of the face of the robot; P is the location of the user's face; γ is the visual angle of the robot; OP represents the distance between the human face and the central point of the picture, the length thereof being denoted by c. After the robot captures a picture, the robot can determine the values of c and a, and then obtain the angle β between the face of the robot and the user's face according to the above equation. In FIG. 3, the robot should rotate by a degree of β rightward so as to ensure that the robot and the user are face to face. Surly, if P is located between O and C, then the robot is required to be rotated by β degrees leftward.

Step 15. Adjusting the robot according to the required adjustment angle.

In this step, the angle of the robot relative to the user is adjusted so that the robot can interact with the user face to face and thus the intellectuality of human-robot interaction is improved; furthermore, the face to face interaction between the robot and the user is more realistic and natural.

In the first embodiment of the invention, determining a corresponding original direction where the voice signal is generated upon receiving a voice signal; adjusting the robot from a current direction to the original direction, and capturing a picture corresponding to the original direction; detecting whether a human face exists in the picture; when a human face exists in the picture, determining a required adjustment angle according to the location of the human face in the picture; adjusting the robot according to the required adjustment angle. Since after the robot is adjusted from the current direction to the original direction, a required adjustment angle is further determined according to the location of the human face in the picture, the obtained positioned location and direction is more precise, and the robot adjusted according to required adjustment angle can interact with the user face to face precisely and improve the intellectuality of human-robot interaction; furthermore, the face to face interaction between the robot and the user is more realistic and natural.

It should be understood that in the embodiments of the present invention, the sequence numbers of the above processes do not mean the execution sequence; the execution sequence of each process should be determined by functions and internal logics thereof, and should not form any limitation to the execution processes of the embodiments of the present invention.

### The Second Embodiment

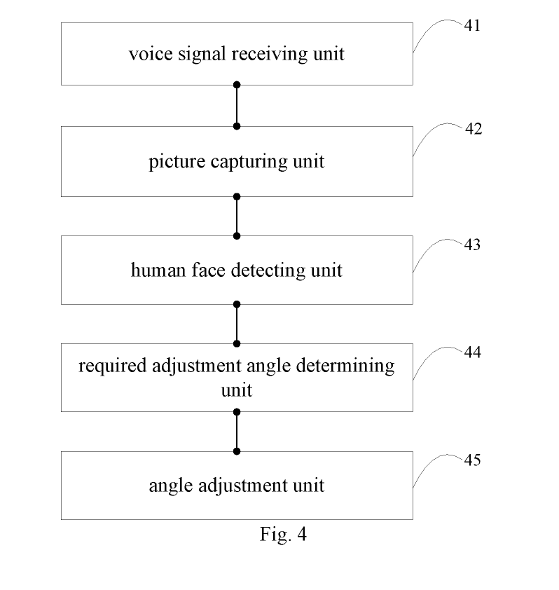

FIG. 4 illustrates a structure diagram of an apparatus for adjusting an interactive direction of a robot provided by the second embodiment of the invention. The apparatus for adjusting an interactive direction of a robot can be applied to a variety of robots. For clarity, only the portions relevant to the embodiment of the present invention are shown.

The apparatus for adjusting an interactive direction of a robot includes a voice signal receiving unit 41, a picture capturing unit 42, a human face detecting unit 43, a required adjustment angle determining unit 44 and an angle adjustment unit 45. Wherein:

The voice signal receiving unit 41 is configured to determine a corresponding original direction where the voice signal is generated upon receiving a voice signal.

Specifically, after receiving the voice signal, the robot estimates the original direction corresponding to the voice signal by utilizing sound source positioning technology. For example, when receiving multiple voice signals, the robot estimates the original direction corresponded to the strongest voice signal by utilizing positioning technology.

Optionally, in order to avoid interference and save electricity, the voice signal receiving unit 41 includes:

A wakeup instruction judging module configured to judge whether the voice signal is a wakeup instruction or not upon receiving the voice signal.

An original direction determining module configured to determine the original direction where the voice signal is generated when the voice signal is a wakeup instruction. Specifically, the original direction corresponded to the voice signal can be estimated through the sound source positioning technology. Surly, if the specific location where the voice signal is generated is required to be determined, then a time difference of received voice signals can be utilized. For example, the robot is configured with four microphones thereon; an array of the four microphones is a four-element cross array, and the four microphones are arranged in the same plane in a cross shape, wherein S denotes the location of voice source; M1, M2, M3, M4 respectively denote locations of four elements (microphones) in the four-element cross array, as shown in FIG. 2. Wherein, a target azimuth angle is φ, and a sound source elevation angle is θ (angle constituted by \vec{OS} and \vec{OX}); γ is a distance between the target voice source (S) and the ordinate origin O; time difference of voices received by two microphones Mᵢ and Mⱼ is denoted by tᵢⱼ. Then, the original direction and location where the voice signal is generated can be determined by the following equation:

$$\{ \begin{matrix}tan φ = \frac{{t}_{41} + {T}_{31} - {t}_{21}}{{t}_{21} + {t}_{31} - {t}_{41}} \\ cos θ = \frac{C}{L} \sqrt{\frac{{t}_{31}^{2} + {( {t}_{41} - {t}_{21} )}^{2}}{2}} \\ r = \frac{C [ {t}_{31}^{2} + {( {t}_{41} - {t}_{21} )}^{2} ]}{4 ( {t}_{41} - {t}_{31} + {t}_{21} )}\end{matrix}$$

Furthermore, the wakeup instruction judging module includes:

A word meaning identifying module configured to identify the meaning of words and sentences contained in the voice signal upon receiving the voice signal, and judge whether the meaning of words and sentences contained in the voice signal is identical with predefined meaning.

Whether-the-voice-signal-is-a-wakeup-instruction judging module configured to: judge whether a frequency and/or tone corresponding to the voice signal is identical with a predefined frequency and/or tone when the meaning of words and sentences contained in the voice signal is identical with the predefined meaning, and if the frequency and/or tone corresponded to the voice signal is identical with a predefined frequency and/or tone, then the voice signal is determined to be a wakeup instruction.

Whether-the-voice-signal-is-not-a-wakeup-instruction judging module configured to: judge that the voice signal is not a wakeup instruction when the meaning of words and sentences contained in the voice signal is not identical with predefined meaning, or the frequency and/or tone corresponded to the voice signal is not identical with the predefined frequency and/or tone.

The picture capturing unit 42 is configured to adjust the robot from a current direction to the original direction, and capture a picture corresponded to the original direction.

After determining the original direction, if the current direction of the robot is not identical with the original direction, the robot is adjusted from the current direction to the original direction, and the picture corresponded to the direction is captured by utilizing a picture capturing apparatus such as a camera, a high-definition colored vidicon; the picture can be a 2D picture or a 3D picture.

The human face detecting unit 43 is configured to detect whether a human face exists in the picture.

The required adjustment angle determining unit 44 is configured to determine a required adjustment angle according to the location of the human face in the picture when a human face exists in the picture.

Optionally, in order to make the communication between the robot and the user more natural and more realistic, a certain adjustment angle is required for the robot to communicate with the user precisely face to face to improve the intellectuality of human-robot interaction. The required adjustment angle determining unit 44 specifically includes:

A human face quantity judging module configured to judge whether the number of the human face is more than one when a human face exists in the picture.

A first required adjustment angle determining module configured to choose the human face with a least depth when the number of the human face is more than one, and determine the required adjustment angle according to the location of the human face with the least depth in the picture.

A second required adjustment angle determining module configured to determine the required adjustment angle according to the location of the human face in the picture when the number of the human face is 1.

In the human face quantity judging module, the first required adjustment angle determining module and the second required adjustment angle determining module, the location of which human face in the picture should be the basis for determining the required adjustment angle is determined: when multiple human faces exist in the picture, the human face with the least depth is chosen, and the required adjustment angle is determined according to the location of the human face with the least depth in the picture. Since the distance between the human and the robot is closer when the depth is shallower, and the possibility that the user is the owner of the robot is higher as the distance with the robot is closer, therefore, the required adjustment angle according to the depth of the human face is more precisely determined. Since when only one human face exists in the picture, the human face normally belongs to the owner of the robot, and then the required adjustment angle can be determined merely according to the location of the human face in the picture.

Optionally, the required adjustment angle determining unit 44 includes:

A picture information determining module configured to determine the distance c between the human face and a central point of the picture, and determine a width α of the picture.

An angle calculating module configured to determine the required adjustment angle:

$$β = arctan \frac{2 c / a}{tan \frac{π - γ}{2}}$$

according to the equation:

$$\{ \begin{matrix}tan α = \frac{2 b}{a} \\ tan β = \frac{c}{b} \\ α = \frac{1}{2} ( π - γ )\end{matrix} ,$$

Wherein, α is the angle between the plane of the picture and the line connecting the robot and the left or right side of the picture; b is the distance between the robot and the central point of the picture; β is the required adjustment angle; γ is the visual angle of the robot. Surly, the required adjustment angle determining unit 44 can include the human face quantity judging module, the first required adjustment angle determining module, the second required adjustment angle determining module, the picture information determining module and the angle calculating module at the same time, which is not limited herein.

The angle adjustment unit 45 is configured to adjust the robot according to the required adjustment angle.

In the second embodiment of the invention, since after the robot is adjusted from the current direction to a determined original direction, a required adjustment angle is further determined according to the location of the human face in the picture, the obtained positioned location and direction is more precise, and the robot adjusted according to required adjustment angle can communicate with the user face to face precisely, thereby improving the intellectuality of human-robot interaction; furthermore, the face to face interaction between the robot and the user is more realistic and natural.

Those skilled in the art should understand that the exemplary units and algorithm steps described in accompany with the embodiments disclosed in the specification can be achieved by electronic hardware, or the combination of computer software with electronic hardware. Whether these functions are executed in a hardware manner or a software manner depends on the specific applications and design constraint conditions of the technical solutions. With respect to each specific application, a professional technician can achieve the described functions utilizing different methods, and these achievements should not be deemed as going beyond the scope of the invention.

It can be clearly understood for those skilled in the art that for convenience and concision of the description, the specific operation processes of the above-described systems, apparatuses and units can make reference to the correspondence processes in the above mentioned method embodiments, and are not repeated here.

It should be understood that the systems, apparatuses and methods disclosed in some embodiments provided by the present application can also be realized in other ways. For example, the described apparatus embodiments are merely schematic; for example, the division of the units is merely a division based on logic function, whereas the units can be divided in other ways in actual realization; for example, a plurality of units or components can be grouped or integrated into another system, or some features can be omitted or not executed. Furthermore, the shown or discussed mutual coupling or direct coupling or communication connection can be achieved by indirect coupling or communication connection of some interfaces, apparatuses or units in electric, mechanical or other ways.

The units described as isolated elements can be or not be separated physically; an element shown as a unit can be or not be physical unit, which means that the element can be located in one location or distributed at multiple network units. Some or all of the units can be selected according to actual needs to achieve the purpose of the schemes of the embodiments.

Furthermore, each functional unit in each embodiment of the present invention can be integrated into a processing unit, or each unit can exist in isolation, or two or more than two units can be integrated into one unit. The integrated unit can be achieved in hardware or in software function unit.

If the integrated unit is achieved in software functional unit and sold or used as an independent product, the integrated unit can be stored in a computer-readable storage medium. Based on this consideration, the substantial part, or the part that is contributed to the prior art of the technical solution of the present invention, or part or all of the technical solutions can be embodied in a software product. The computer software product is stored in a storage medium, and includes several instructions configured to enable a computer device (can be a personal computer, device, network device, and so on) to execute all or some of the steps of the method of each embodiment of the present invention. The storage medium includes a U disk, a mobile hard disk, a read-only memory (ROM, Read-Only Memory), a random access memory (RAM, Random Access Memory), a disk or a light disk, and other various mediums which can store program codes.

The above contents merely describe specific embodiments of the present invention, which are not intended for limiting the protection scope of the present invention; anyone ordinarily skilled in the art can readily envisage modifications and equivalents to the technical solutions without departing from the scope disclosed by the present invention, which should be within the protection scope of the invention. Therefore, the protection scope of the present invention should be based on the claims.

1. A method for adjusting robot interactive directions of robots, wherein the method comprises:
determining an original direction where a voice signal is generated upon receiving a voice signal;
adjusting a robot from a current direction to the original direction, and capturing a picture corresponding to the original direction;
detecting whether a human face exists in the picture;
when a human face exists in the picture, determining a required adjustment angle according to a location of the human face in the picture; and
adjusting the robot according to the required adjustment angle.

2. The method of claim 1, wherein the step of when a human face exists in the picture, determining a required adjustment angle according to a location of the human face in the picture comprises:
when a human face exists in the picture, judging whether the number of the human face is more than one;
when the number of the human face is more than 1, choosing the human face with a least depth, and determining the required adjustment angle according to the location of the human face with the least depth in the picture; and
when the number of the human face is 1, determining the required adjustment angle according to the location of the human face in the picture.

3. The method of claim 1, wherein the step of determining a required adjustment angle according to a location of the human face in the picture comprises:
determining a distance c between the human face and a central point of the picture; determining a width a of the picture;
according to equation:
$$\{ \begin{matrix}tan α = \frac{2 b}{a} \\ tan β = \frac{c}{b} \\ α = \frac{1}{2} ( π - γ )\end{matrix} ,$$
determining the required adjustment angle:
$$β = arctan \frac{2 c / a}{tan \frac{π - γ}{2}} ;$$
Wherein, α is an angle between a plane where the picture lies and a line connecting the robot with a left or right side of the picture; b is a distance between the robot and a central point of the picture; β is the required adjustment angle; γ is a visual angle of the robot.

4. The method of claim 1, wherein the step of determining an original direction where a voice signal is generated upon receiving a voice signal comprises:
upon receiving the voice signal, judging whether the voice signal is a wakeup instruction or not; and
when the voice signal is a wakeup instruction, determining the original direction where the voice signal is generated.

5. The method of claim 4, wherein the step of upon receiving the voice signal, judging whether the voice signal is a wakeup instruction or not comprises:
upon receiving the voice signal, identifying meaning of words and sentences contained in the voice signal, and judging whether the meaning of the words and sentences contained in the voice signal is identical with predefined meaning;
if the meaning of the words and sentences contained in the voice signal is identical with the predefined meaning, judging whether a frequency and/or tone of the voice signal is identical with a predefined frequency and/or tone; if the frequency and/or tone of the voice signal is identical with the predefined frequency and/or tone, determining that the voice signal is a wakeup instruction;
if the meaning of the words and sentences contained in the voice signal is not identical with the predefined meaning or the frequency and/or tone of the voice signal is not identical with the predefined frequency and/or tone, determining that the voice signal is not a wakeup instruction.

6. A robot interactive direction adjustment apparatus, wherein the apparatus comprises:
a voice signal receiving unit configured to determine an original direction where the voice signal is generated upon receiving a voice signal;
a picture capturing unit configured to adjust the robot from a current direction to the original direction, and capture a picture corresponded to the original direction;
a human face detecting unit configured to detect whether a human face exists in the picture;
a required adjustment angle determining unit configured to determine a required adjustment angle according to a location of the human face in the picture when a human face exists in the picture; and
an angle adjustment unit configured to adjust the robot according to the required adjustment angle.

7. The apparatus of claim 6, wherein the required adjustment angle determining unit comprises:
a human face quantity judging module configured to judge whether the number of the human face is more than one when a human face exists in the picture;
a first required adjustment angle determining module configured to choose the human face with a least depth when the number of the human face is more than one, and determine the required adjustment angle according to the location of the human face with the least depth in the picture; and
a second required adjustment angle determining module configured to determine the required adjustment angle according to the location of the human face in the picture when the number of the human face is 1.

8. The apparatus of claim 6, wherein the required adjustment angle determining unit comprises:
a picture information determining module configured to determine a distance c between the human face and a central point of the picture, and determine a width a of the picture;
an angle calculating module configured to determine the required adjustment angle:
$$β = arctan \frac{2 c / a}{tan \frac{π - γ}{2}}$$
according to equation:
$$\{ \begin{matrix}tan α = \frac{2 b}{a} \\ tan β = \frac{c}{b} \\ α = \frac{1}{2} ( π - γ )\end{matrix} ,$$
wherein, α is an angle between a plane of the picture and a line connecting the robot and left or right side of the picture; b is a distance between the robot and a central point of the picture; β is the required adjustment angle; γ is a visual angle of the robot.

9. The apparatus of claim 6, wherein the voice signal receiving unit comprises:
a wakeup instruction judging module configured to judge whether the voice signal is a wakeup instruction or not upon receiving the voice signal; and
an original direction determining module configured to determine the original direction where the voice signal is generated when the voice signal is a wakeup instruction.

10. The apparatus of claim 9, wherein the wakeup instruction judging module comprises:
a word meaning identifying module configured to identify meaning of words and sentences contained in the voice signal upon receiving the voice signal, and judge whether the meaning of the words and sentences contained in the voice signal is identical with predefined meaning;
whether-the-voice-signal-is-a-wakeup-instruction judging module configured to judge whether a frequency and/or tone corresponded to the voice signal is identical with a predefined frequency and/or tone; when the meaning of the words and sentences contained in the voice signal is identical with the predefined meaning, and the frequency and/or tone corresponded to the voice signal is identical with a predefined frequency and/or tone, then the voice signal is determined to be a wakeup instruction; and
whether-the-voice-signal-is-not-a-wakeup-instruction judging module configured to judge that the voice signal is not a wakeup instruction when the meaning of the words and sentences contained in the voice signal is not identical with predefined meaning, or the frequency and/or tone corresponded to the voice signal is not identical with the predefined frequency and/or tone.
